(19) United States
(12) Patent Application Publication
(10) Pub. No.: US 2019/0044176 A1
(43) Pub. Date: Feb. 7, 2019

(54) DEVICE FOR ASSEMBLING POWER BATTERY

(71) Applicants: Junxiong ZHOU, Guangdong (CN); Junhao ZHOU, Guangdong (CN); Junjie ZHOU, Guangdong (CN)

(72) Inventors: Junxiong ZHOU, Guangdong (CN); Junhao ZHOU, Guangdong (CN); Junjie ZHOU, Guangdong (CN)

(21) Appl. No.: 15/782,871

(22) Filed: Oct. 13, 2017

(30) Foreign Application Priority Data
Aug. 4, 2017 (CN) 201710662201.1

(51) Int. Cl. H01M 10/04; B23P 19/04

(52) U.S. Cl. CPC H01M 10/0404; Y10S 483/901; B23P 19/04

(57) ABSTRACT

Disclosed is a device for assembling a power battery, comprising a roller conveyor, a storage rack and a high speed intelligent robot, wherein the roller conveyor is sequentially provided thereon with a tooling plate and empty tray input station, a heat dissipation plate assembly station, a battery module assembly station, a hold-down strip and locking screw assembly station, a copper bar and distribution box assembly station, a sampling wire and fuse box assembly station, and a discharge station; the storage rack and the high speed intelligent robot are disposed on the battery module assembly station. The device for assembling a power battery can automatically assemble a battery module, record and track product information, and reduce the dependency of the product on an operator, thus saving labor cost, reducing labor strength, and improving qualified product rate to a certain extent.

### BACKGROUND OF THE INVENTION

The present invention relates to a semi-automatic assembly device, in particular to a device for assembling a battery.

With the constant development of the electronic industry, power battery has a greater and greater influence on the daily life of people, and has gradually gained the attention of people. At present, the power battery is produced with an operator cooperated with single workstations, wherein the workstations are connected via a transfer line. The production process requires the operator to manually assemble a battery module into a tray; the great weight of the power battery module extremely improves the labor strength of manual assembly; furthermore, the assembly process of the power battery has a high requirement for the proficiency of a worker, thus having the problems of reduced yield and low good finished product rate due to certain unavoidable human factors.

### BRIEF SUMMARY OF THE INVENTION

The problem to be solved by the present invention is providing an assembly device for automatically assembling a battery module. The device for assembling a battery can record and track product information in each production link.

The present invention discloses a device for assembling a power battery, comprising a roller conveyor, a storage rack and a high speed intelligent robot, wherein the roller conveyor is sequentially provided thereon with a tooling plate and empty tray input station, a heat dissipation plate assembly station, a battery module assembly station, a hold-down strip and locking screw assembly station, a copper bar and distribution box assembly station, a sampling wire and fuse box assembly station, and a discharge station; the storage rack and the high speed intelligent robot are disposed on the battery module assembly station; a module assembly manipulator and a CCD imaging visual system are disposed on the high speed intelligent robot. The CCD imaging visual system is used for positioning a tray, and accounting the number of the products on the storage rack. When the products on the storage rack reaches the assembly number of the tray, the module assembly manipulator places the products on the tray, and installs the module in place, such that the battery module can be automatically charged and installed, thus saving labor cost, and reducing labor strength.

Further, the high speed intelligent robot is a six-axis robot, and the module assembly manipulator is provided with three sets of clamping jaws.

Further, the clamping jaws can automatically replace each other; once a different product model is changed, a robot can automatically replace the clamping jaws as required, thus improving work efficiency.

Further, the heat dissipation plate assembly station is used for assembling an air cooling plate or a water cooling plate to dissipate heat and cool the battery.

Further, the tooling plate and empty tray input station and the discharge station are respectively provided with an automated guided vehicle, thus saving labor cost, reducing labor strength, and improving work efficiency.

Further, the copper bar and distribution box assembly station can be further used for assembling a maintenance switch.

Further, the sampling wire and fuse box assembly station is provided with an electrostatic test device, thus facilitating the further detection of product-related performances.

Further, each station is provided with an abnormality alarm device; once an abnormality occurs during production, the alarm device can prompt an operator, such that the operator can shoot the trouble in time, thus ensuring the smooth ongoing of the production.

Further, each station is provided with a code scanning device for the operator to manually scan a product and upload information to an EMS system, such that the product information in each production chain link can be recorded and tracked.

The present invention has the following beneficial effects:

Compared to the prior art, the device for assembling a power battery disclosed by the present invention can automatically assemble a battery module, record and track product information, and reduce the dependency of the product on an operator, thus saving labor cost, reducing labor strength, and improving qualified product rate to a certain extent.

### BRIEF DESCRIPTION OF THE DRAWINGS

FIG. 1 is a structural schematic view of the device for assembling a power battery.

### DETAILED DESCRIPTION OF THE INVENTION

The preferred embodiments of the present invention will be elaborated hereinafter in connection with the drawings, such that the advantages and characteristics of the present invention can be understood more easily by a person skilled in the art, and the protection scope of the present invention can be defined more clearly and explicitly.

### Embodiment 1

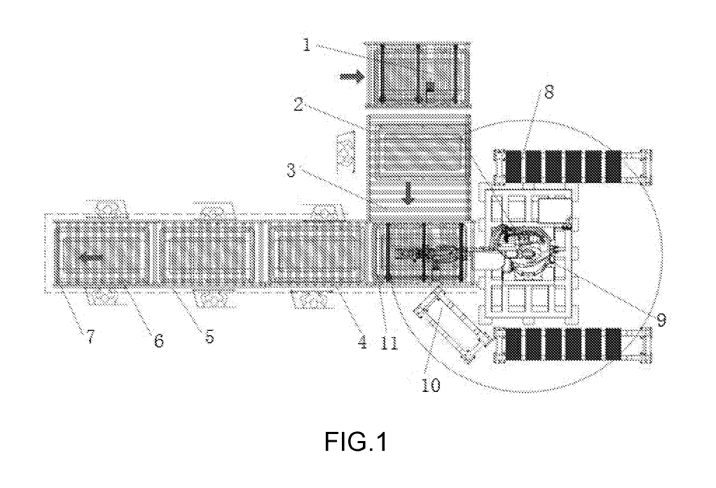

As shown in FIG. 1, a device for assembling a power battery, comprising a roller conveyor 3, a storage rack 10 and a high speed intelligent robot 9, wherein the roller conveyor 3 is sequentially provided thereon with a tooling plate and empty tray input station 1, a heat dissipation plate assembly station 2, a battery module assembly station 11, a hold-down strip and locking screw assembly station 4, a copper bar and distribution box assembly station 5, a sampling wire and fuse box assembly station 6, and a discharge station 7; the storage rack 10 and the six-axis robot 9 are disposed on the battery module assembly station 11; a module assembly manipulator 8 and a CCD imaging visual system are disposed on the six-axis robot 9; three sets of quick-replace clamping jaws are disposed on the module assembly manipulator 8, thus facilitating automatic replacement when a different product model is changed, and improving work efficiency. The CCD imaging visual system is used for positioning a tray, accounting the number of the products on the storage rack 10, cooperating with the module assembly manipulator 8 to place the products on the tray, and installing the module in place. The tooling plate and empty tray input station 1 and the discharge station 7 are respectively provided with an automated guided vehicle; the sampling wire and fuse box assembly station 6 is provided with an electrostatic test device. In addition, each station is provided with an abnormality alarm device and a code scanning device, wherein the code scanning device is connected to an EMS system signal.

### Embodiment 2

The process for assembling a power battery is as follows:

First, the automated guided vehicle conveys a tooling plate and an empty tray to the tooling plate and empty tray input station 1 on the roller conveyor 3; the tooling plate and the empty tray are conveyed by the roller conveyor 3 to the heat dissipation plate assembly station 2 to install a water cooling plate for heat dissipation, and are then conveyed by the roller conveyor 3 to the battery module assembly station 11; the robot 9 assembled on the battery module assembly station 11 positions the tray via the CCD visual system, while the visual system accounts the number of the module products on the storage rack 10. When the number of the modules on the storage rack reaches the assembly number of the tray, the visual system cooperates with the module assembly manipulator 8 to transfer the modules onto the tray, and installs the modules in place via the module assembly manipulator 8. After the modules are installed, the tooling plate and the tray are conveyed by the roller conveyor 3 to the hold-down strip and locking screw assembly station 4 to manually complete hold-down strip assembly and screw locking; then, the tooling plate and the tray are transferred to the copper bar and distribution box assembly station 5 to manually and sequentially complete the assembly of a copper bar, a distribution box and a maintenance box; then, the tooling plate and the tray are conveyed by the roller conveyor 3 to the sampling wire and fuse box assembly station 6 to still manually and sequentially complete the assembly of a sampling wire, a fuse box and a BIC; the sampling wire and fuse box assembly station 6 can further perform an electrostatic test on the assembled power battery; after the related performances thereof are detected, the finished product can be carried away by the automated guided vehicle from the discharge station 7.

The embodiments of the present invention are elaborated here above in connection with the drawings. However, the present invention is not limited to the embodiments above, and may have various variations in the knowledge scope of an ordinarily person skilled in the art without departing from the spirit of the present invention.

What is claimed is:

1. A device for assembling a power battery, characterized by, comprising a roller conveyor (3), a storage rack (10) and a high speed intelligent robot (9), wherein the roller conveyor (3) is sequentially provided thereon with a tooling plate and empty tray input station (1), a heat dissipation plate assembly station (2), a battery module assembly station (11), a hold-down strip and locking screw assembly station (4), a copper bar and distribution box assembly station (5), a sampling wire and fuse box assembly station (6), and a discharge station (7); the storage rack (10) and the high speed intelligent robot (9) are disposed on the battery module assembly station (11); a module assembly manipulator (8) and a CCD imaging visual system for positioning a tray are disposed on the high speed intelligent robot (9).

2. The device for assembling a power battery as claimed in claim 1, characterized in that, the high speed intelligent robot (9) is a six-axis robot, and the module assembly manipulator (8) is provided with three sets of clamping jaws.

3. The device for assembling a power battery as claimed in claim 2, characterized in that, the clamping jaws can automatically replace each other.

4. The device for assembling a power battery as claimed in claim 1, characterized in that, the heat dissipation plate assembly station (2) is used for assembling an air cooling plate or a water cooling plate.

5. The device for assembling a power battery as claimed in claim 1, characterized in that, the tooling plate and empty tray input station (1) and the discharge station (7) are respectively provided with an automated guided vehicle.

6. The device for assembling a power battery as claimed in claim 1, characterized in that, the copper bar and distribution box assembly station (5) can be further used for assembling a maintenance switch.

7. The device for assembling a power battery as claimed in claim 1, characterized in that, the sampling wire and fuse box assembly station (6) is provided with an electrostatic test device.

8. The device for assembling a power battery as claimed in claim 1, characterized in that, each station is provided with an abnormality alarm device.

9. The device for assembling a power battery as claimed in claim 1, characterized in that, each station is provided with a code scanning device which is connected to an EMS system signal.
